(19) United States
(12) Patent Application Publication
(10) Pub. No.: US 2006/0248251 A1
(43) Pub. Date: Nov. 2, 2006

(54) Accessory docking station for a portable information device

(76) Inventors: James L. Tracy, Coral Springs, FL (US); Rohan T. Kale, Weston, FL (US); Tom Mathew, Skokie, IL (US); Irfan Nasir, Lake In The Hills, IL (US); Amy D. Perkins, Davie, FL (US); Jon L. Schindler, Glenview, IL (US); Bharat N. Vakil, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/118,457

(22) Filed: Apr. 29, 2005

(51) Int. Cl. G06F 13/00

(52) U.S. Cl. 710/303

(57) ABSTRACT

A charger docking station (102) is used to charge a battery (122) of a portable information device (104), and provide enhanced input (110) and enhanced output (112) ability. The enhanced input allows a user to more easily input information into the portable information device, while the enhanced output allows the user to view more information than may be displayed by a display (126) of the portable information device. When the charger docking station is connected to a power source (116) a power supply (114) provides power to the enhanced input and display elements, but when the power source is disconnected from the power supply, the enhanced input and display elements are powered from the battery of the portable information device, or from an external auxiliary battery (106), or both.

### TECHNICAL FIELD

This invention relates in general to portable information devices, and more particularly to charger accessories and docking stations for portable information devices.

### BACKGROUND OF THE INVENTION

Portable information devices such as mobile communication devices and personal digital assistants are in common use throughout the world. These devices typically have a display for displaying information to the user of the device, and an input means such as a keypad for accepting commands and information from the user. One feature of these devices that is critical to the marketability is their size. In general, users prefer smaller devices as they are easier to carry on their person. The desirability of reducing the size of these devices presents several challenges to manufactures of these devices. For one, a smaller size generally means a smaller battery supply, which makes it necessary to conserve battery power because operating time is also an important feature in marketing these devices. Secondly, the small size of the device limits the size of displays and keypad. Therefore there is a need for providing enhanced input and display functionality for such devices without significantly impacting battery life.

### BRIEF DESCRIPTION OF THE DRAWINGS

FIG. 1 shows a block schematic diagram of a portable information device docking system, in accordance with an embodiment of the invention;

FIG. 2 shows an isometric view of a portable information device docking system, in accordance with an embodiment of the invention;

FIG. 3 shows a block schematic diagram illustrating power flow in a portable information device docking system when the portable information device docking system is not connected to a power source, in accordance with an embodiment of the invention; and

FIG. 4 shows an isometric view of a portable information device docking system, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

The invention solves the problem of providing enhanced input and display functionality without reducing battery life by providing a docking station for the device that provides charging ability, and enhanced input and display functionality.

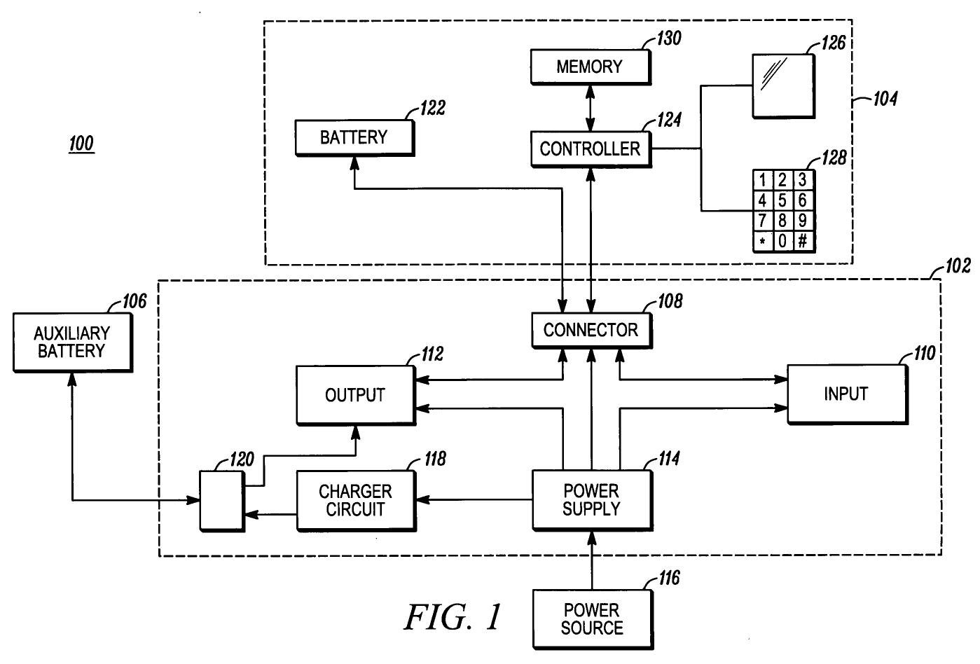

Referring now to FIG. 1, there is shown a block schematic diagram of a portable information device docking system 100, in accordance with an embodiment of the invention. The system includes a docking station 102 and a portable information device 104. An auxiliary battery 106 may be charged by the docking station as well. The auxiliary battery is one which may be used to power the device 104, and may be used as a spare battery. The portable information device may be any number of small, handheld devices, such as, for example, a cellular phone, or personal digital assistant. The portable information device 104 connects to the docking station via a connector 108, which may be a conventional multi-conductor connector for passing power and signals between the docking station and portable information device. The docking station provides an enhanced input means 110 which allows the user of the device to input information into the device in a more convenient manner than using the input means 128 of the device itself. Similarly, the docking station provides a display means 112 for providing an enhanced output or display of information over the display 126 of the device. A power supply 114 provides power to the input means and display means, as well as the portable information device, while the power supply is connected to a power source 116. The power supply may be a conventional power supply for converting a power source voltage of 110 VAC to a 5 VDC level, for example. However, when the power supply is not connected to a power source, the input means and display means optionally be powered by a battery 122 of the device. Furthermore, in an embodiment where an auxiliary battery is hosted by the docking station, the docking station includes a charger circuit 118 and a second connection means 120 for coupling to the auxiliary battery. The power supply provides power to the charger circuit when the power supply is connected to a power source. When the power supply is not connected to a power source, the auxiliary battery may provide power to the display means 112, the input means, or both.

The portable information device 104 controls operation of the input means 110 and display means 112 when connected to the docking station 102, at the option of the user. The device contains a controller 124 for controlling operation of the device and the devices input 128 and display 126. Furthermore the device contains a memory 130 for storing information and instruction code for operating the device. The device receives power from the docking station, which it may use to charge the battery 122 in addition to power the circuitry of the device. The device's input 128 may be, for example, a conventional phone keypad as is commonly found of cellular phone devices. Although such keypads allow the entry of text, often multiple keypresses are required to select a desired letter as each key or button of the keypad is assigned multiple characters. Alternatively, specialized software may be used by the controller to anticipate a word being entered by the user based on the sequence of key presses and the probability that a given word being entered matches possible words that may be formed by the characters assigned to those keys in the sequence they are pressed. However, anticipating the word a user is entering depends on the device having a library of words, and if the word being entered is not in the library, the user still has to essentially spell out the word. Thus, when the user desires to enter a significant amount of information or complex or specialized words or information, the user may place the device into the docking station 102 and use the enhanced input means 110 to enter the information. The input means 110 provides enhanced functionality over the input of the device 128, such as by providing a conventional QWERTY keypad, as is commonly used with computer keyboards/keypads. Similarly, the display means 112 may be used by the device 104 for displaying information on the device with enhanced functionality compared to the display 126 of the device. For example, the display means 112 may display more information at a time than can be displayed on the display 126 of the device. Although the power supply 114 provides power to the docking station 102 and device 104 while connected to a power source, it is contemplated that the user may desire to use the enhanced input and output of the docking station when the power supply is not connected to a power source, or in the event of an intermittency in the provision of power from the power source. To provide the enhanced functionality when the power supply is not powered by the power source, the battery 122 of the device may be used to power at least one of the input means and display means. Similarly, the auxiliary battery 106 may be used, when present, to power either the display means 112 or input means 110, or both, when the power source is not provided to the power supply.

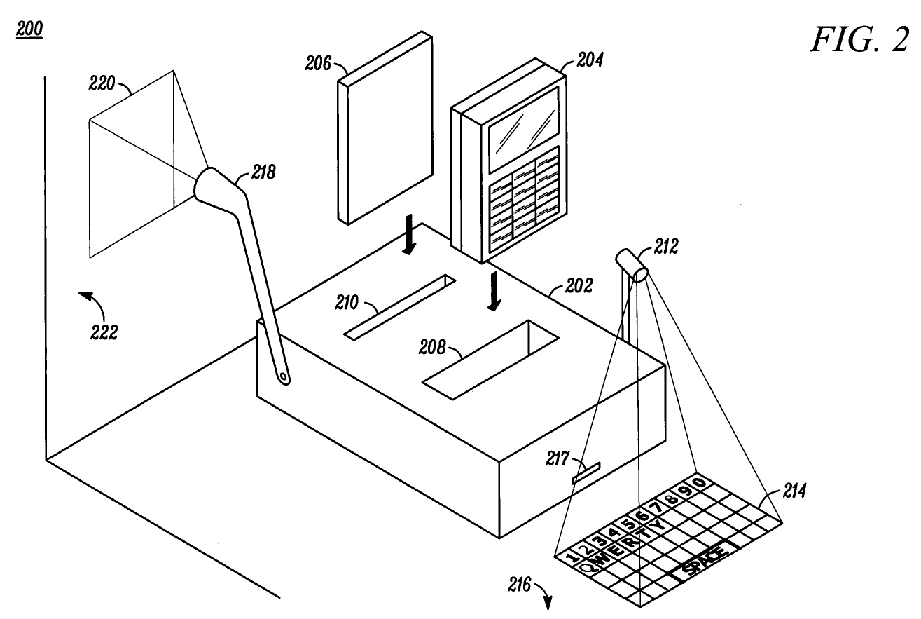

Referring now to FIG. 2, there is shown an isometric view of a portable information device docking system 200, in accordance with an embodiment of the invention. The system shown here is an embodiment of the system represented by the block schematic of FIG. 1. The system includes a docking station 202 which hosts a portable information device 204 and, optionally, an auxiliary battery 206. The portable information device may be, for example, a mobile communication device, and is hosted in a first pocket 208 of the docking station. The device 204 is provided with a connector that mates with a corresponding connector in the first pocket, as is commonly known. The auxiliary battery 206 is hosted in a second pocket 210 of the docking station, and is charged by the docking station.

In one embodiment of the invention, the input means is a provided by a virtual projection keypad, wherein the input means is a virtual projection keypad subsystem. By virtual it is meant that an actual, physical keypad is not present, but instead a light image of one is apparent to the user. In one embodiment of the invention, the virtual projection keypad is provided by a projector 212 projecting an image of a keypad 214 on a surface 216 in proximity to the docking station. As the user touches the virtual buttons, and location of the users fingers may be determined by an infrared detector 217, as is known in the art. The virtual keypad may be, for example, a conventional QWERTY keypad. Similarly, the display means may be provided by a projection display provided by a virtual display subsystem including a projector 218 which projects a virtual display 220 onto a surface 222 in proximity to the docking station. The virtual display is an apparent display created by a light image, as opposed to an actual display such as a liquid crystal display to cathode ray tube display. In one embodiment of the invention the virtual display is projected behind the docking station and the virtual keypad is projected in front of the docking station, where the projected display and projected keypad are provided on opposite sides of the docking station, although the two projections may be provided in any number of configurations. It is contemplated that the virtual keypad projector and virtual display projector are mounted on the docking station in a manner that allows them to be swiveled or rotated into position from an inactive position alongside the docking station. When a projector is moved into an operating position, the corresponding subsystem is activated and controlled by the device 204.

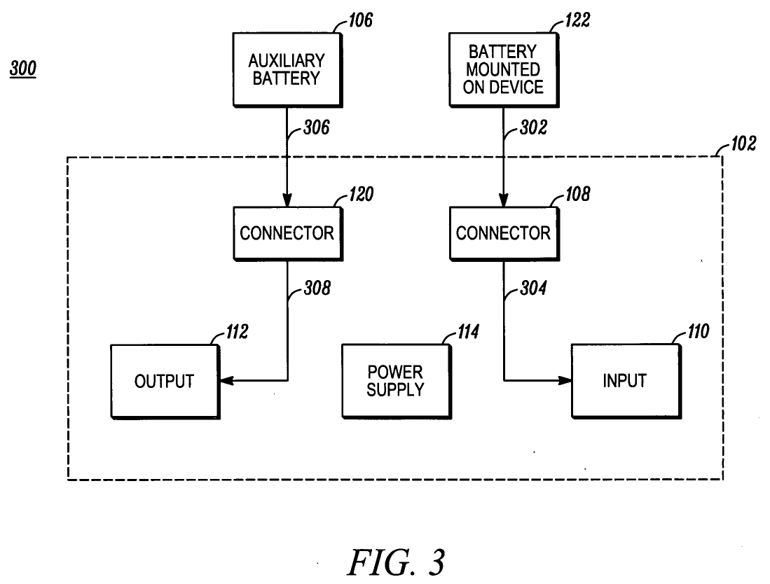

Referring now to FIG. 3, there is shown a block schematic diagram illustrating power flow in a portable information device docking system 300 when the portable information device docking system is not connected to a power source, in accordance with an embodiment of the invention. In the particular embodiment shown here, the battery 122 of the device provides power to the input means 110 through the connector 108, as indicated by the arrows 302, 304. The input means may be an enhanced input subsystem such as a hardware keypad, or virtual projection subsystem, for example. Similarly, the auxiliary battery 106 may be used to power the enhanced display subsystem 112 through the connector 120, as indicated by arrows 306, 308. However, when the docking station is connected to a power source, the power supply 114 will provide power to the enhanced input and enhanced output or display. It is contemplated that the docking station is designed such that the power flow occurs automatically, so that if the docking station is unplugged from the power source during operation, power from the battery or batteries will maintain a continuous flow of power to the subsystems of the docking station.

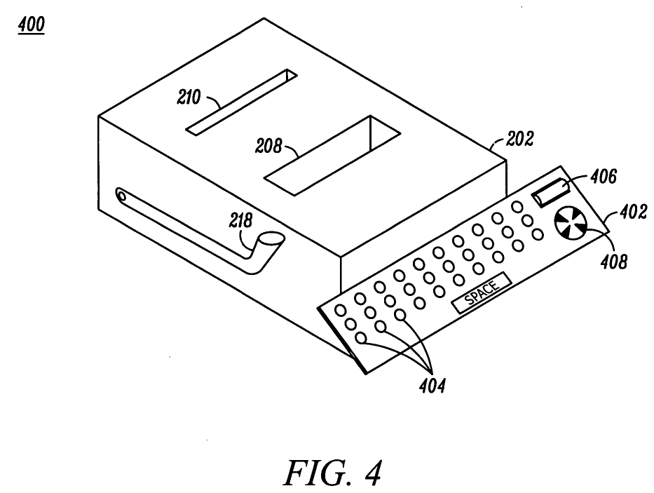

Referring now to FIG. 4, there is shown an isometric view of a portable information device docking system 400, in accordance with an embodiment of the invention. In the present embodiment, the docking station utilizes a hardware keypad 402 to provide the enhanced input. The hardware keypad provides keys or buttons 404 in an arrangement such as QWERTY keypad, for example. Furthermore it is contemplated that a navigation device may be provided, such as a roller 406, or a multi-axis button 408, or both. The roller acts to permit scrolling of information displayed by the enhanced display subsystem. The multi-axis button allows navigation in multiple directions and my be used, for example, as pointing device to move a cursor or pointer on the display in a two dimensional manner, as is known.

Therefore, the invention provides a docking station for a portable information device. The docking station has a connector means for hosting the portable information device, which may also serve to hold or support the portable information device. The docking station also has an input means for accepting a user input, such as, for example, a keypad or other plurality of buttons, touch screen, or virtual input. To display information, the docking station comprises a display means for displaying information to a user. To power the components of the docking station, and the portable information device, the docking station also has a power supply. However, in the event of the power supply losing power, such as when it becomes disconnected from a power source, or equivalently when the power source loses power, according to the invention the battery of the portable information device powers at least one of the input means and display means. That is, when power from the power source ceases, the battery of the portable information device may be used to power the docking station, or subsystems of the docking station. In one embodiment of the invention, the input means uses a virtual projection keypad. In one embodiment of the invention, the display means includes a projection display for projecting information onto a surface in proximity to the docking station to be viewed by he user. In an alternative embodiment, the docking station may provide charging for an auxiliary battery. The auxiliary battery is preferably identical to the battery coupled to the portable information device, but meant to be a spare battery carried by the user to replace the battery presently coupled to the device in the event it becomes discharged due to use. The inclusion of the auxiliary battery in the present embodiment allows for the auxiliary battery to power one or more of the subsystems of the docking station in the event the power source loses power or the docking station is unplugged from the power source.

The invention also provides for a portable information device docking system, including a portable information device having a keypad, a display, a battery, and connector. The portable information device is used with a docking station, which has a virtual keypad subsystem, a virtual display subsystem, and a power supply for supplying power to the portable information device, virtual keypad subsystem, and virtual display subsystem. The virtual keypad subsystem provides a virtual keypad which provides enhanced functionality relative to the keypad of the portable information device. The virtual display subsystem provides a virtual display with enhanced functionality over the display of the portable information device. The virtual keypad subsystem and virtual display subsystem are powered from the power supply when the power supply is connected to a power source, but by the battery of the portable information device when the power supply of the docking station is not connected to the power source. In one embodiment of the invention the virtual keypad subsystem is a projection keypad subsystem for projecting the image of a keypad on a surface adjacent the docking station. The projection keypad subsystem also detects key selection by the user of the docking station. Another aspect of the invention provides that the virtual display subsystem may be a projection display subsystem. The docking station may also include an auxiliary battery pocket for hosting an auxiliary battery to be used with the portable information device, and a charger for charging the auxiliary battery. The auxiliary battery may then be used to provide power to the virtual keypad subsystem, the virtual display subsystem, or both, when the power supply is not connected to the power source.

The invention also provides a charger docking station for a mobile communication device. The mobile communication device includes a conventional phone keypad, phone display, and a battery. The charger docking station has a first pocket for hosting the mobile communication device and connecting to the mobile communication device for communicating signals and power between the charger docking station and the mobile communication device. The charger docking station also provides an enhanced input subsystem for providing information input to the mobile communication device, and an enhanced display subsystem for providing a visual display of information on the mobile communication device. To provide charging functionality, the charger docking station provides a power supply for providing power to the mobile communication device, enhanced keypad subsystem, and enhanced display subsystem when the power supply is connected to a power source. In the event that power is disconnected from the power supply, the battery of the mobile communication device provides power to the enhanced keypad subsystem, the enhanced display subsystem, or both. In one embodiment of the invention, the enhanced input subsystem is a QWERTY keypad. The QWERTY keypad may be provided by a projection system projecting an image of a QWERTY keypad on a surface in proximity to the charger docking station and detecting when spaces corresponding to individual keys of the QWERTY keypad are contacted by a user. In another embodiment of the invention, the QWERTY keypad is provided by a roll-up keypad. The invention may also provide that the enhanced input subsystem includes a navigation device, such as a roller for scrolling information displayed by the enhanced display subsystem, or a multi-axis button, or both. The enhanced display subsystem may be a projection system for projecting a display on a surface in proximity to the charger docking station. Furthermore, the charger docking station may provide a second pocket for hosting an auxiliary battery for use with the mobile communication device which, in addition to acting as a spare battery for the portable information device when used out of the charger docking station may, while disposed in the second pocket, be used for providing power the enhanced input subsystem, enhanced display subsystem, or both when the power supply is not connected to a power source.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A docking station for a portable information device, comprising:
connector means for hosting the portable information device;
input means for accepting a user input;
display means for displaying information to a user; and
a power supply for providing power to the input means, display means, and a charging means disposed in the portable information device when the power supply is connected to a power source;
wherein the battery of the portable information device powers at least one of the input means and display means when the power supply is not connected to the power source.

2. A docking station as defined in claim 1, wherein the input means comprises a virtual projection keypad.

3. A docking station as defined in claim 1, wherein the display means comprises a projection display.

4. A docking station as defined in claim 1, further comprising an auxiliary battery pocket for accepting a battery for use with the portable information device, the charging means coupled to the auxiliary battery pocket for charging the auxiliary battery, and wherein the auxiliary battery powers at least one of the input means and display means when the power supply is not connected to the power source.

5. A portable information device docking system, comprising:
a portable information device having a keypad, a display, a battery, and connector;
a docking station for hosting the portable information device and having a virtual keypad subsystem, a virtual display subsystem, and a power supply for supplying power to the portable information device, virtual keypad subsystem, and virtual display subsystem, and wherein the virtual keypad subsystem provides a virtual keypad having enhanced functionality relative to the keypad of the portable information device, and wherein the virtual display subsystem provides a virtual display having enhanced functionality over the display of the portable information device;
wherein the virtual keypad subsystem and virtual display subsystem are powered from the power supply when the power supply is connected to a power source; and
wherein at least one of the virtual keypad subsystem and virtual display subsystem are powered by the battery of the portable information device when the power supply of the docking station is not connected to the power source.

6. A portable information device docking system as defined in claim 5, wherein the virtual keypad subsystem is a projection keypad subsystem for projecting the image of a keypad on a surface adjacent the docking station, and for detecting key selection by a user of the docking station.

7. A portable information device docking system as defined in claim 5, wherein the virtual display subsystem is a projection display subsystem.

8. A portable information device docking system as defined in claim 5, wherein the docking station further comprises:
an auxiliary battery pocket for hosting an auxiliary battery to be used with the portable information device; and
a charger for charging the auxiliary battery;
wherein the auxiliary battery powers at least one of the virtual keypad subsystem and virtual display subsystem when the power supply is not connected to the power source.

9. A charger docking station for a mobile communication device, the mobile communication device having a phone keypad, a phone display, and a battery, the charger docking station comprising:
a first pocket for hosting the mobile communication device and connecting to the mobile communication device for communicating signals and power between the charger docking station and the mobile communication device;
an enhanced input subsystem for providing input to the mobile communication device;
an enhanced display subsystem for providing a visual display of information on the mobile communication device;
a power supply for providing power to the mobile communication device, enhanced keypad subsystem, and enhanced display subsystem when the power supply is connected to a power source;
wherein the battery of the mobile communication device is charged when the power supply is connected to the power source; and
wherein the battery of the mobile communication device provides power to at least one of the enhanced keypad subsystem and enhanced display subsystem when the power supply is not connected to a power source.

10. A charger docking station as defined in claim 9, wherein the enhanced input subsystem comprises a QWERTY keypad.

11. A charger docking station as defined in claim 10, wherein the QWERTY keypad is provided by a projection system projecting an image of a QWERTY keypad on a surface in proximity to the charger docking station and detecting when spaces corresponding to individual keys of the QWERTY keypad are contacted by a user.

12. A charger docking station as defined in claim 10, wherein the QWERTY keypad is provided by a roll-up keypad.

13. A charger docking station as defined in claim 9, wherein the enhanced input subsystem comprises a navigation device..

14. A charger docking station as defined in claim 13, wherein the navigation device comprises a roller for scrolling information displayed by the enhanced display subsystem.

15. A charger docking station as defined in claim 13, wherein the navigation device comprises a multi-axis button.

16. A charger docking station as defined in claim 9, wherein the enhanced display subsystem comprises a projection system for projecting a display on a surface in proximity to the charger docking station.

17. A charger docking station as defined in claim 9, further comprising:
a second pocket for hosting an auxiliary battery for use with the mobile communication device; and
a charging circuit for charging the auxiliary battery when the auxiliary battery is present in the second pocket and when the power supply is connected to the power source, the power supply providing power to the charging circuit.

18. A charger docking station as defined in claim 17, wherein the auxiliary battery provides power to at least one of the enhanced input subsystem and enhanced display subsystem when the power supply is not connected to a power source.
